(19) United States
(12) Patent Application Publication
(10) Pub. No.: US 2022/0067822 A1
(43) Pub. Date: Mar. 3, 2022

(54) INFORMATION PROCESSING APPARATUS, INFORMATION PROCESSING SYSTEM, AND INFORMATION PROCESSING METHOD

(71) Applicant: TOYOTA JIDOSHA KABUSHIKI KAISHA, Tokyo-shi (JP)

(72) Inventors: Tomoya Matsubara, Seto-shi (JP); Ibuki Shimada, Miyoshi-shi (JP); Keisuke Shoji, Nagoya-shi (JP); Shuhei Yamamoto, Aichi-gun (JP); Hideo Hasegawa, Nagoya-shi (JP); Yurika Tanaka, Yokosuka-shi (JP); Satoshi Komamine, Nagoya-shi (JP)

(73) Assignee: TOYOTA JIDOSHA KABUSHIKI KAISHA, Toyota-shi (JP)

(21) Appl. No.: 17/391,550

(22) Filed: Aug. 2, 2021

(30) Foreign Application Priority Data
Aug. 25, 2020 (JP) 2020-141996

(51) Int. Cl. G06Q 30/06; G06F 16/2457; G06F 16/28

(52) U.S. Cl. CPC G06Q 30/0645; G06F 16/289; G06F 16/2457

(57) ABSTRACT

An information processing apparatus includes a controller configured to monitor movement of at least one object that is owned by a first user, based on information detected by a sensor, and create a list of lendable objects from the at least one object, based on the movement of the at least one object. The controller adds an object a frequency of use of which is smaller than a first value, among the at least one object, to the list as the lendable object.

### CROSS REFERENCE TO THE RELATED APPLICATION

This application claims the benefit of Japanese Patent Application No. 2020-141996, filed on Aug. 25, 2020, which is hereby incorporated by reference herein in its entirety.

### BACKGROUND

### Technical Field

The present disclosure relates to an information processing apparatus, an information processing system, and an information processing method.

### Description of the Related Art

There is disclosed a lending/borrowing system for contents that allows users to lend and borrow electronic books among themselves, and that manages a state of lending/borrowing in an objective manner (for example, Patent Document 1).

[Patent Document 1] Japanese Patent Laid-Open No. 2012-155486

### SUMMARY

The present disclosure is aimed at providing an information processing apparatus, an information processing system, and an information processing method that enable management of lendable objects that are physical objects owned by individuals.

An aspect of the present disclosure is an information processing apparatus comprising a controller configured to:

monitor movement of at least one object that is owned by a first user, based on information detected by a sensor, and

create a list of lendable objects from the at least one object, based on the movement of the at least one object.

Another aspect of the present disclosure is an information processing system comprising:

a sensor installed in a space where at least one object that is owned by a first user is placed; and

a controller configured to

monitor movement of the at least one object based on information detected by the sensor, and

create a list of lendable objects from the at least one object, based on the movement of the at least one object.

Another aspect of the present disclosure is an information processing method comprising:

monitoring movement of at least one object that is owned by a first user, based on information detected by a sensor; and

creating a list of lendable objects from the at least one object, based on the movement of the at least one object.

According to the present disclosure, lendable objects that are physical objects owned by individuals may be managed.

### BRIEF DESCRIPTION OF THE DRAWINGS

FIG. 1 is a diagram illustrating an example of a system configuration of an interindividual item lending/borrowing system according to a first embodiment;

FIG. 2 is an example of hardware components of the center server;

FIG. 3 is a diagram illustrating an example of functional components of the center server;

FIG. 4 is a diagram illustrating an example of information that is stored in the user information database;

FIG. 5 is a diagram illustrating an example of information that is stored in the item information database;

FIG. 6 is a diagram illustrating an example of information that is stored in the tag information database;

FIG. 7 is a diagram illustrating an example of the lendable list;

FIG. 8 is an example of the flowchart of the item registration process by the center server;

FIG. 9 is an example of the flowchart of a lendable list update process by the center server;

FIG. 10 is an example of the flowchart of an initial position update process by the center server;

FIG. 11 is an example of the flowchart of list management process by the center server;

FIG. 12 is an example of the flowchart of list management process by the center server;

FIG. 13 is an example of the flowchart of list management process by the center server;

FIG. 14 is a flowchart of the lending management process by the center server; and

FIG. 15 is an example of a flowchart of the item management process about management of an item according to a use state, performed by the center server.

### DESCRIPTION OF THE EMBODIMENTS

An aspect of the present disclosure is an information processing apparatus including a controller configured to monitor movement of at least one object that is owned by a first user, based on information detected by a sensor, and edit a list of lendable objects based on the movement of the object. The objects include books, clothes, shoes, bags, household electrical appliances such as a clothes iron, and outdoor gear, for example. Target objects in an aspect of the present disclosure are not limited to those listed above. The sensor may be an RF tag attached to an object and an RF reader disposed in the periphery of a location where the object is placed, a camera whose imaging range includes the location where the object is placed, an optical sensor, a radar, or the like, for example. The movement of an object occurs when the object is used by the first user or is lent to another user, for example.

According to an aspect of the present disclosure, the list of lendable objects is edited in accordance with movement of objects, and thus, lendable objects among objects owned by an individual may be managed while reducing burden on the owner.

According to an aspect of the present disclosure, the controller may add an object a frequency of use of which is smaller than a first value, among the at least one object, to the list as the lendable object. When an object with a high frequency of use is lent to a user other than the first user, who is the owner, inconvenience is possibly caused to the first user as in a case where the object is lent and not available when the first user wants to use the object, for example. On the other hand, when objects with low frequencies of use are lent to other users, the amount of garbage in a town as a whole may be reduced due to the amount of objects owned by residents being reduced, for example.

According to an aspect of the present disclosure, the controller may remove, from the list, a first object that is being used by the first user, among objects included in the list. Furthermore, the controller may remove, from the list, a second object that is no longer detected by the sensor, among objects included in the list. In such cases, the controller may add the first object or the second object to the list when the first object or the second object is placed at a predetermined position. This allows the list of lendable objects to be automatically updated in accordance with the use of an object by the first user or lending of an object to another user.

Furthermore, according to an aspect of the present disclosure, the controller may further propose the first user to give away or discard a third object a frequency of use of which is smaller than a second value, among the at least one object. Alternatively, the controller may propose the first user to give away, to a second user, a fourth object a frequency of use of which by the first user is smaller than the second value and that is lent to the second user at a frequency at or greater than a third value, among the at least one object. The first user is thus able to grasp presence of a possession with a low frequency of use. Furthermore, a method of utilizing a possession with a low frequency of use may be proposed.

In the following, an embodiment of the present disclosure will be described with reference to the drawings. The configuration of the embodiment described below is an example, and the present disclosure is not limited to the configuration of the embodiment.

### First Embodiment

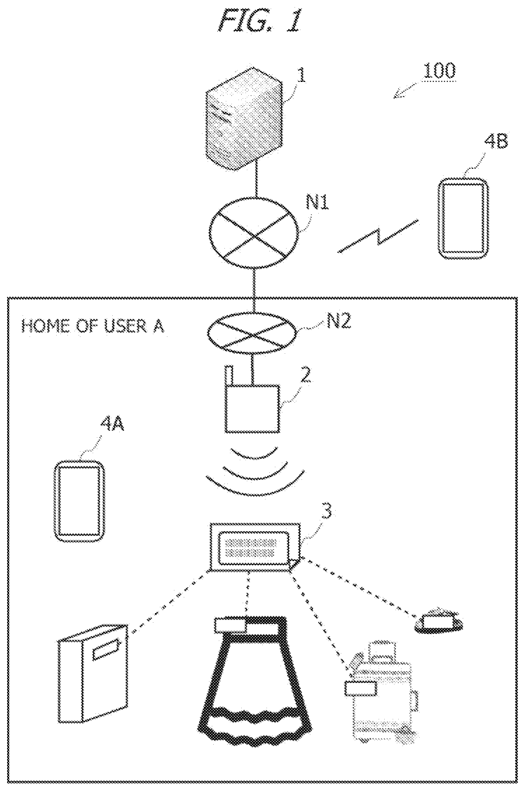

FIG. 1 is a diagram illustrating an example of a system configuration of an interindividual item lending/borrowing system 100 according to a first embodiment. The interindividual item lending/borrowing system 100 is a system that allows lending and borrowing of items owned by individuals among the individuals. For example, the interindividual item lending/borrowing system 100 includes a center server 1, an RF reader 2 installed at a home of a user, an RF tag 3 attached to an item owned by the user, and a user terminal 4. A user owns a plurality of items, and the RF tag 3 is attached to each item. The RF tag 3 is a sticker type, for example.

The center server 1 is connected to a network N1. The RF reader 2 is connected to a network N2 in the home of the user, and is connected to the network N1 through the network N2 in a manner capable of communicating with the center server 1. The network N1 is the Internet, for example. The network N2 is a local area network (LAN), for example.

The RF reader 2 is installed at a high position in a space where the items are placed, for example. The RF tag 3 is attached to an item lending of which to another user is allowed by the user. In the following, a user owning an item will be referred to as an owner user. An owner user is an example of “first user”. An item is an example of “object”.

An item that the owner user allows to be lent to another user is an item for which a frequency of use by the owner user is smaller than a predetermined value, for example. Specifically, items that the owner user allows to be lent to another user include, but are not limited to, books, clothes, household electrical appliances such as a clothes iron, suitcases, and outdoor gear, for example. A space where the items are placed is a predetermined room in the home of the owner user, for example.

The RF tag 3 may be attached to the item by the owner user, or may be attached at a shop at the time of purchase under permission from the owner user, for example.

The RF reader 2 transmits a predetermined radio signal or electromagnetic signal at predetermined intervals, and receives a return signal from the RF tag 3, for example. The return signal from the RF tag 3 includes identification information on the RF tag, for example. The RF reader 2 acquires a position of the RF tag 3 based on a radio wave intensity and/or a reception direction of the return signal from the RF tag 3, for example, and transmits the position to the center server 1. The intensity of radio wave emitted from the RF reader 2 is set such that a reachable range is within the home of the owner user. That is, position information on the RF tag 3 is acquired when an item to which the RF tag 3 is attached is present inside the home of the owner user, but the position information on the RF tag 3 is not acquired when the item to which the RF tag 3 is attached is taken out of the home of the owner user.

The intervals at which the RF reader 2 acquires the position information on the RF tag 3 may be arbitrarily set in units of one minute to ten minutes, for example. Additionally, the return signal from the RF tag 3 may also include identification information on the owner user, in addition to the identification information on the RF tag 3, for example. In a case where the identification information on the owner user set in the RF reader 2 is not included in the return signal from the RF tag 3, the RF reader 2 may keep from acquiring the position information on the RF tag 3. Accordingly, for example, even in a case where an item of another owner user is also present inside the home in a mixed manner, the position information on the RF tag 3 that is attached to the item of such other owner user is not detected.

The combination of the RF reader 2 and the RF tag 3 is an example of “sensor”. Additionally, the sensor for acquiring position information on an item is not limited to the combination of the RF reader 2 and the RF tag 3, and may alternatively be a camera that is installed in a room where the item is placed, a GPS receiver attached to the item, or a receiver or a transmitter for Bluetooth (registered trademark) low energy (BLE) attached to the item, for example.

The center server 1 monitors the position information on the RF tag 3 that is received from the RF reader 2, and monitors a use state of a corresponding item based on the movement of the RF tag 3. The center server 1 manages a list of lendable items based on use states of items. In the following, the list of lendable items will be referred to as “lendable list”.

The center server 1 manages a lending of items. For example, when a rental request for an item X is received from a user terminal 4B, the center server 1 searches the lendable list of each user, and notifies the user terminal 4B of information about the item X that is lendable. For example, in a case where a condition regarding an item owner is set in relation to a user who wants to borrow, and/or in a case where a condition regarding a borrowing user is set in relation to a lending user, an item satisfying such conditions is extracted as the lendable item. Such conditions include gender, age group, address, and the like, for example.

When an item to be lent is determined, the center server 1 determines methods of handing over and returning the item that is lent, for example. The methods of handing over and returning the item that is lent may be a method according to which the borrowing user goes to the home of the user owning the item, a method of determining a hand-over location, a method of performing transfer from the home of the owner user to a location specified by the borrowing user by an autonomous vehicle, or the like, for example. Which method is to be adopted for handing over may be specified by the borrowing user, for example.

In a case where there is an item that is not used by the owner user for a predetermined period of time, the center server 1 proposes the owner user to let go of the item. As an example of letting go, the center server 1 proposes the owner user to sell the item or to give away the item to a user who often borrows the item.

According to the first embodiment, an item that is owned by a user and that is lendable to another user is automatically managed. Accordingly, the burden on the owner user regarding lending of an item to another user may be reduced. This may promote lending and borrowing of items in a neighborhood, and the amount of items owned by individuals may be reduced for a town as a whole, for example. Unnecessary objects may thereby be reduced, and the amount of garbage may be reduced, for example.

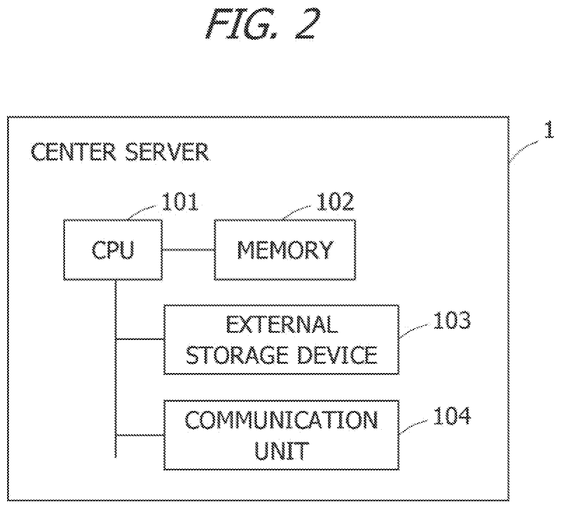

FIG. 2 is an example of hardware components of the center server 1. As hardware components, the center server 1 includes a CPU 101, a memory 102, an external storage device 103, and a communication unit 104. The memory 102 and the external storage device 103 are computer-readable recording media. The center server 1 is an example of “information processing apparatus”.

The external storage device 103 stores various programs, and data that is used by the CPU 101 at the time of execution of each program. For example, the external storage device 103 is an erasable programmable ROM (EPROM) and/or a hard disk drive. Programs held in the external storage device 103 include an operating system (OS), a control program of the interindividual item lending/borrowing system 100, and various other application programs, for example.

The memory 102 is a main memory that provides the CPU 101 with a storage area where programs that are stored in the external storage device 103 are loaded and a work area, and that is used as a buffer. For example, the memory 102 includes semiconductor memories such as a read only memory (ROM) and a random access memory (RAM).

The CPU 101 performs various processes by loading the OS and various application programs held in the external storage device 103 into the memory 102, and by executing the same. There may be a plurality of CPUs 101 without being limited to one. The CPU 101 is an example of “controller”.

The communication unit 104 is a wired network card for local area network (LAN) or a dedicated line, for example, and is connected to the network N1 through an access network such as the LAN. The hardware components of the center server 1 are not limited to those illustrated in FIG. 2.

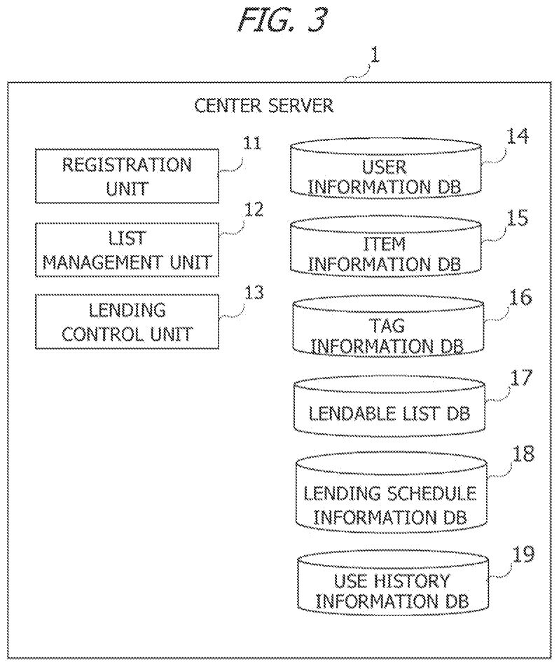

FIG. 3 is a diagram illustrating an example of functional components of the center server 1. As functional components, the center server 1 includes a registration unit 11, a list management unit 12, a lending control unit 13, a user information database (DB) 14, an item information DB 15, a tag information DB 16, a lendable list DB 17, a lending schedule information DB 18, and a use history information DB 19. These functional structural elements are implemented by the center server 1 executing predetermined programs including the control program of the interindividual item lending/borrowing system 100, for example.

The registration unit 11 manages registration of an item that the owner user allows to be lent to another user. Specifically, the registration unit 11 receives input from a predetermined server or a notification from a user terminal of the owner user, registers information about an item in the item information DB 15, and registers information about the association between the item and the RF tag 3 attached to the item in the tag information DB 16, for example.

The list management unit 12 manages the lendable list for each owner user. For example, the list management unit 12 receives the position information on each RF tag 3 from the RF reader 2 at predetermined intervals. The position information on the RF tag 3 is also the position information on the corresponding item. The intervals at which the position information on the RF tag 3 is transmitted is arbitrarily set in units of one minute to five minutes, for example. The list management unit 12 manages the lendable list for each owner user based on the position information on the RF tag 3.

The list management unit 12 detects the movement of a corresponding item from the position information on the RF tag 3, and detects the use of the item by the owner user. The list management unit 12 records use by the owner user in the use history information DB 19.

The list management unit 12 specifies the frequency of use and a use pattern of an item by the owner user by referring to the use history information DB 19. The frequency of use may be acquired by dividing the number of times of use by the number of days in a predetermined period of time, or may be the number of times of use in a predetermined period of time. However, the manner of determining the frequency of use is not limited to those mentioned above. It is also possible to determine an average value of frequencies of use. The list management unit 12 determines an item the frequency of use of which by the owner user is smaller than a predetermined value to be a lendable item, and adds the same to the lendable list. A threshold for the frequency of use may be set for each item, for example. The threshold for the frequency of use is a value indicating once a week, once a month, once a year, or the like, for example. The use pattern is the day of the week, the season and the like when the owner user uses the item with high frequency, for example. Additionally, there are items for which the use pattern is not specified. An item the frequency of use of which is smaller than a predetermined value and for which the use pattern is specified are removed from the lendable list on a date and time matching the specified use pattern.

The list management unit 12 determines, based on the position information on the RF tag 3, use of the corresponding item by the owner user or lending of the corresponding item to another user, and updates the lendable list based on the determination result. For example, in a case of detecting use of the item by the owner user or lending of the item to another user, the list management unit 12 removes the item from the lendable list. Furthermore, for example, in a case of detecting end of use of the item by the owner user or return of the item from another user, the list management unit 12 adds the item to the lendable list.

Moreover, based on the use history information DB 19, the list management unit 12 proposes the owner user to let go of an item the frequency of use of which by the owner user is smaller than a predetermined value. For example, a threshold for the frequency of use used to determine proposing letting go is lower than the threshold used to determine addition to the lendable list. The threshold for the frequency of use used to determine proposing letting go is an example of “second value”. The proposal to let go is performed in the form of a proposal of listing on a flea market service, a proposal to give away to another user, or a proposal of disposal, for example.

For example, the list management unit 12 may refer to the lending schedule information DB 18, and when there is an item regarding which the number of times or the frequency of lending to a specific user is high, the list management unit 12 may propose giving away the item to such a user. For example, the list management unit 12 may refer to the item information DB 15, and may propose disposal of an item that has been present for a predetermined number of years. Additionally, the term “owner user” used in relation to “use of an item by the owner user” includes users who are capable of using the item inside the home of the owner user. Users who are capable of using an item inside the home of the owner user include family members and housemates of the owner user, for example.

The lending control unit 13 manages lending of items. For example, when a lending request is received from a user terminal 4, the lending control unit 13 extracts lending target item(s) from the item information DB 15. Furthermore, the lending control unit 13 extracts lendable item(s) registered in the lendable list(s), from the extracted item(s). Furthermore, in a case where a condition regarding the owner user is set in relation to the user who is the source of the lending request, or in a case where a condition regarding a user who is the receiving end of lending is set in relation to the owner user, an item satisfying such a condition is extracted. The lending control unit 13 transmits information about extracted item(s) to the user terminal 4 that is the transmission source of the lending request. When a selection result for an item to be borrowed is received from the user terminal 4 that is the transmission source of the lending request, the lending control unit 13 registers a lending schedule for the item in the lending schedule information DB 18.

Furthermore, the lending control unit 13 may communicate with the user terminal 4 that is the transmission source of the lending request or the user terminal 4 of the owner user, and determine the method of handing over and returning the item. For example, the method of handing over an item may be a method according to which the borrowing user goes to the home of the owner user, a method according to which the borrowing user and the owner user of the item go to a hand-over location of the item, or a method according to which transfer is performed by a vehicle. For example, the lending control unit 13 determines the hand-over location or a transfer schedule in accordance with a selection of the borrowing user or the owner user. For example, a small autonomous vehicle may be adopted as the method of transferring an item. In the case where an item is to be transferred by a small autonomous vehicle, the lending control unit 13 notifies a server managing the small autonomous vehicle of information about a lending schedule of the item, and requests that arrangement for delivery be made.

Completion of handing over or completion of return of the item is notified of by, for example, the user terminal 4 of the borrowing user. The lending control unit 13 updates the lending schedule in accordance with the notification from the user terminal 4 of the borrowing user.

The user information DB 14, the item information DB 15, the tag information DB 16, the lendable list DB 17, the lending schedule information DB 18, and the use history information DB 19 are created in a storage area of the external storage device 103 of the center server 1. Information about the user is stored in the user information DB 14. Information about an item that the owner user allows to be lent to another user is stored in the item information DB 15. Information about the RF tag 3 that is attached to an item is stored in the tag information DB 16. The lendable list of each user is stored in the lendable list DB 17. Information about a use history of each item is stored in the use history information DB 19.

Information about a lending schedule is stored in the lending schedule information DB 18. Specifically, information pieces such as identification information on an item to be lent, identification information on the owner user, identification information on the borrowing user, a lending period, information about handing over of the item and the like are stored in the lending schedule information DB 18. However, information pieces to be stored in the lending schedule information DB 18 are not limited to those listed above.

Information about the use history of the owner user is stored in the use history information DB 19. Specifically, the identification information on the RF tag 3, the identification information on the owner user of the item to which the RF tag 3 is attached, information indicating a date and time when use is detected and the like are included in the use history information DB 19. However, information pieces to be stored in the use history information DB 19 are not limited to those listed above.

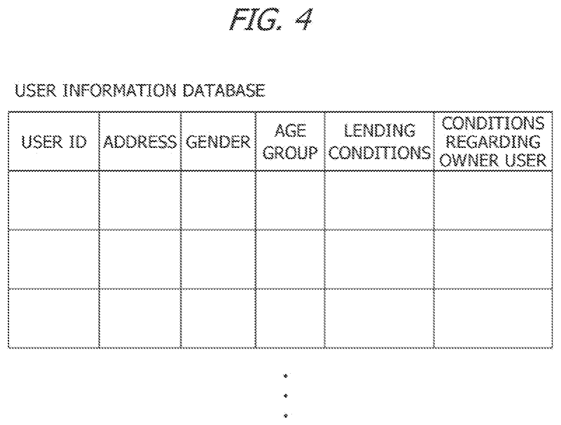

FIG. 4 is a diagram illustrating an example of information that is stored in the user information DB 14. Information about a user is stored in the user information DB 14. One record in the user information DB 14 that is illustrated as an example in FIG. 4 includes the following fields: user ID, address, gender, age group, lending conditions, and conditions regarding owner user.

The identification information on a user who is registered in the interindividual item lending/borrowing system 100 is stored in the field “user ID”. The address of the home of the user is stored in the field “address”. The gender of the user is stored in the field “gender”. The age group of the user is stored in the field “age group”.

Conditions regarding a party to whom the user as the owner user lends an item are stored in the field “lending conditions”. Conditions regarding the owner user of an item in a case where the user is the borrowing user are stored in the field “conditions regarding owner user”. The lending conditions and the conditions regarding owner user include gender, age group, address coverage and the like. Fields “lending conditions” and “conditions regarding owner user” are optional. Additionally, information pieces to be stored in the user information DB 14 are not limited to those illustrated in FIG. 4.

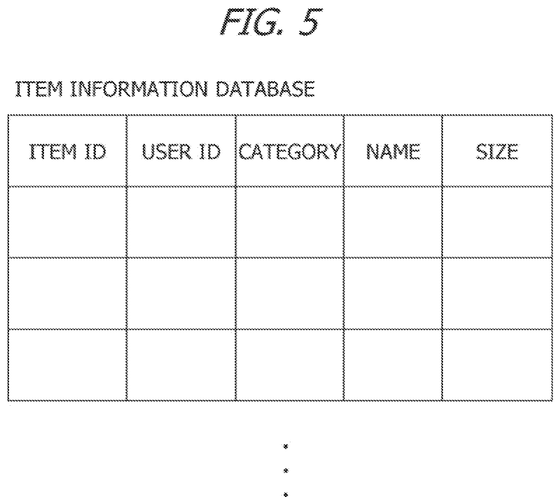

FIG. 5 is a diagram illustrating an example of information that is stored in the item information DB 15. Information about an item that the owner user allows to be lent to another user is stored in the item information DB 15. In the example illustrated in FIG. 5, one record in the item information DB 15 includes the following fields: item ID, user ID, category, name, and size.

The identification information on an item is stored in the field “item ID”. The identification information on the owner user of the item is stored in the field “user ID”. Information indicating the category of the item is stored in the field “category”. The information indicating the category of the item may be a code, a flag, or text, for example. The name of the item is stored in the field “name”. Information about the size of the item is stored in the field “size”.

Information to be stored in the item information DB 15 may be acquired through input by the user at the time of registration of the item, for example. Alternatively, information to be stored in the item information DB 15 may be acquired on the Web with the name or the like of the item as the keyword. Additionally, information pieces to be stored in the item information DB 15 are not limited to those illustrated in FIG. 5. For example, the fields included in the record in the item information DB 15 may be changed as appropriate in accordance with the type of the item.

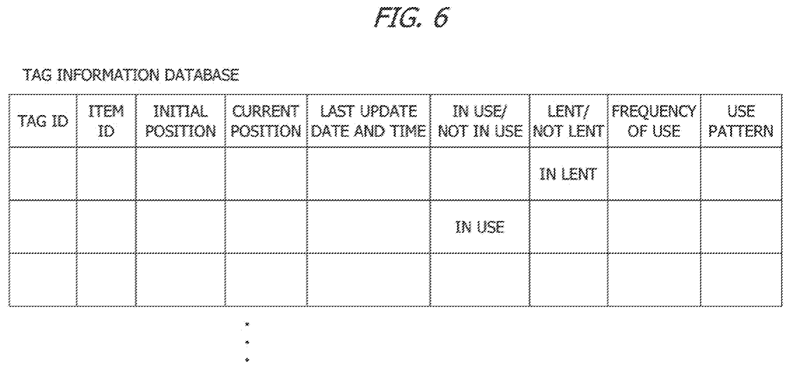

FIG. 6 is a diagram illustrating an example of information that is stored in the tag information DB 16. The tag information DB 16 stores information about the RF tag 3 that is attached to an item. One record in the tag information DB 16 illustrated in FIG. 6 includes the following fields: tag ID, item ID, initial position, current position, in use/not in use, lent/not lent, last update date and time, frequency of use, and use pattern.

The identification information on an RF tag 3 is stored in the field “tag ID”. The identification information on the item to which the RF tag 3 is attached is stored in the field “item ID”. Information indicating an initial position of the RF tag 3 is stored in the field “initial position”. Information indicating a current position of the RF tag 3 is stored in the field “current position”. Information indicating a date and time of update of the field “current position” is stored in the field “last update date and time”. The position information on the RF tag 3 may be indicated by coordinates in a space where the item to which the RF tag 3 is attached is placed, for example.

Information indicating whether or not the item to which the RF tag 3 is attached is being used by the owner user is stored in the field “in use/not in use”. The information indicating whether or not the item is being used by the owner user is a flag, for example. However, in FIG. 6, the information indicating in use or not in use is in text for the sake of convenience.

Information indicating whether or not the item to which the RF tag 3 is attached is being lent to another user is stored in the field “lent/not lent”. The information indicating whether or not the item is being lent to another user is a flag, for example. Note that, in FIG. 6, the information indicating lent or not lent is in text for the sake of convenience.

Information indicating the frequency of use of the item to which the RF tag 3 is attached is stored in the field “frequency of use”. The frequency of use is indicated by the number of times per day, week, month, or year, for example. However, the frequency of use is not limited to those listed above. For example, a code, a flag, or the like indicating a class of the frequency of use may be stored in the field “frequency of use” as the information indicating the frequency of use.

Information indicating the use pattern of the item to which the RF tag 3 is attached is stored in the field “use pattern”. For example, the use pattern may be indicated by the day of the week, weekdays or weekends, beginning, middle or end of a month, month name, season or the like.

For example, the field “initial position” is updated by the list management unit 12 at a predetermined timing. An update timing of the field “initial position” is, but not limited to, a predetermined time once a day, for example.

For example, the fields “current position” and “last update date and time” are each updated by the list management unit 12 every time the position information on the RF tag 3 is received. The fields “in use/not in use” and “lent/not lent” are each updated by the list management unit 12 every time use by the owner or lending to another user is detected.

The fields “frequency of use” and “use pattern” are each updated by the list management unit 12 at a predetermined timing. The update timings of the fields “frequency of use” and “use pattern” are each predetermined date and time in a week, a month, or a year, for example. Additionally, information pieces to be stored in the tag information DB 16 are not limited to those illustrated in FIG. 6.

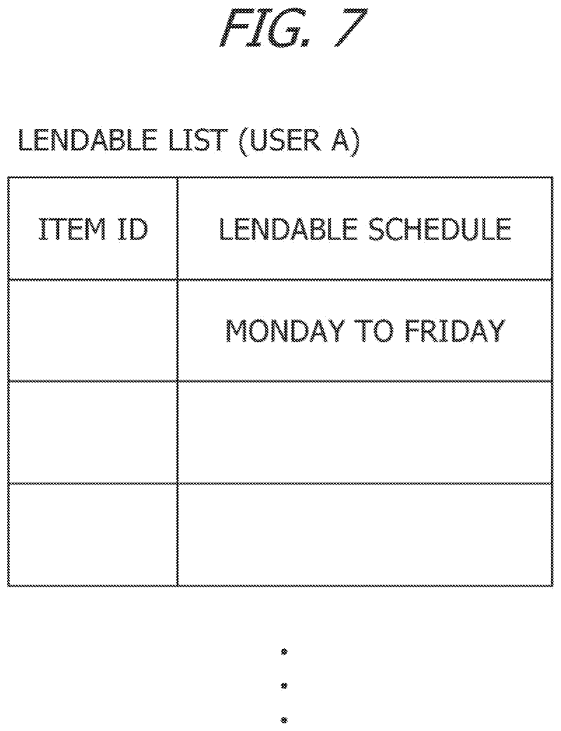

FIG. 7 is a diagram illustrating an example of the lendable list. The lendable list illustrated in FIG. 7 is a list of items that are in a lendable state, among items owned by a user A. The lendable list is created for each owner user, for example. The lendable list is stored in the lendable list DB 17.

The lendable list includes the following fields: item ID and lendable schedule. The identification information on an item that is in a lendable state is stored in the field “item ID”. Information pieces such as the day of the week and a time slot when lending is possible are stored in the field “lendable schedule”. A value is set in the field “lendable schedule” in the case where the use pattern of the item is specified.

The lendable list is updated by the list management unit 12 in accordance with the use state or a borrowed state of the item. Additionally, information pieces to be stored in the lendable list are not limited to those illustrated in FIG. 7.

<Flow of Processes>

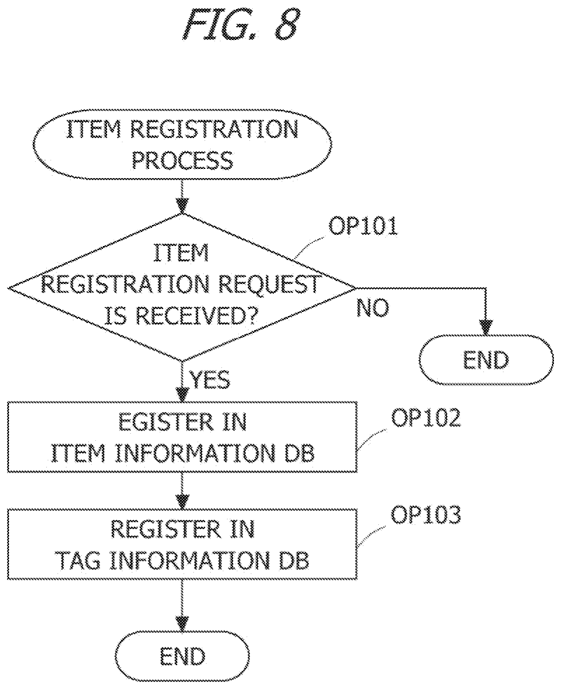

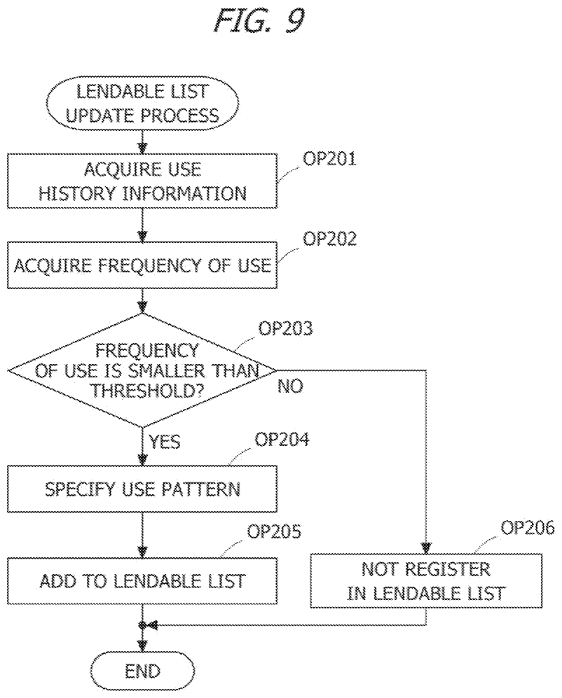

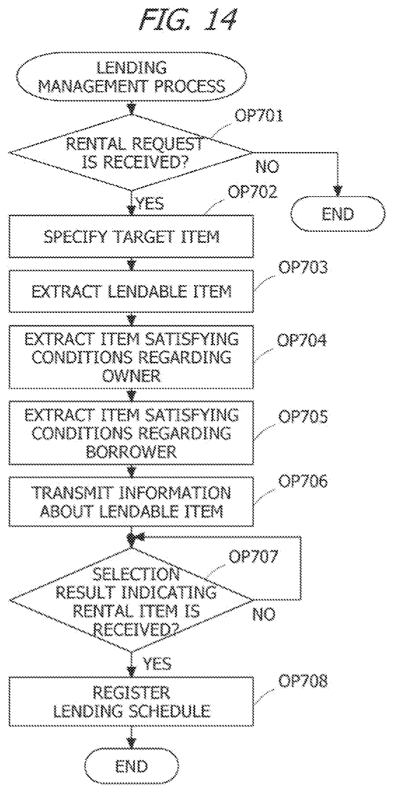

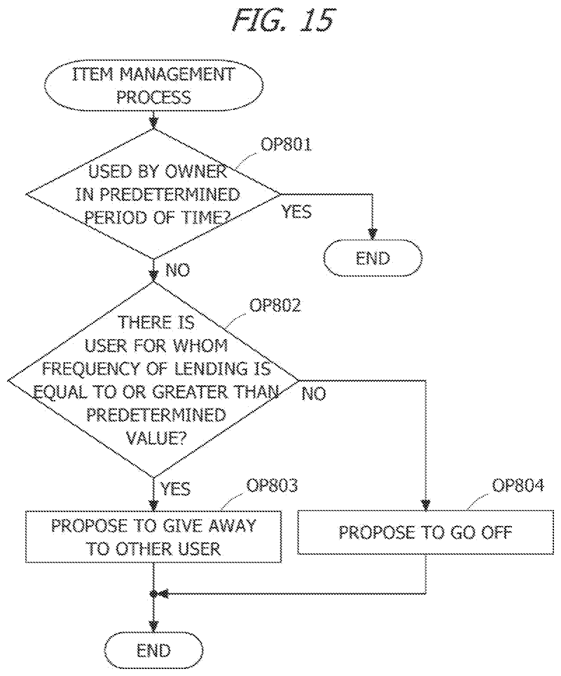

Processes in the interindividual item lending/borrowing system 100 are broadly divided into an item registration process, a lendable list management process, a lending management process about lending of an item, and an item management process about management of an item according to the use state. FIG. 8 is a flowchart of a process that is categorized as the item registration process. FIGS. 9 to 13 are flowcharts of processes that are categorized as the lendable list management process. FIG. 14 is a flowchart of a process that is categorized as the lending management process about lending of an item. FIG. 15 is a flowchart of the item management process about management of an item according to the user state. The main performer of the flowcharts illustrated in FIGS. 8 to 15 is the CPU 101 of the center server 1, but a description will be given taking a functional structural element in charge of a respective process as the performer for the sake of convenience.

FIG. 8 is an example of the flowchart of the item registration process by the center server 1. The process illustrated in FIG. 8 is repeatedly performed at predetermined intervals, for example.

In OP101, the registration unit 11 determines whether or not an item registration request is received. The item registration request is a request to register an item in the interindividual item lending/borrowing system 100. For example, the item registration request is transmitted to the center server 1 from a server of a seller of the item coordinating with interindividual item lending/borrowing system 100 or from the user terminal 4. For example, the name of the item, the identification information on the RF tag 3 that is attached to the item, the identification information on the owner user, and the like are also received together with the item registration request. However, information pieces that are received together with the item registration request are not limited to those listed above. For example, more detailed information about the item may be received. More detailed information about the item may be the category, the size, and the like, for example.

In the case where the item registration request is received (OP101: YES), the process proceeds to OP102. In the case where the item registration request is not received (OP101: NO), the process illustrated in FIG. 8 is ended.

In OP102, the registration unit 11 attaches identification information to the item received together with the item registration request, and performs registration in the item information DB 15. Information that is missing in relation to registration in the item information DB 15 may be acquired through web search with the name of the item as the keyword, for example.

In OP103, the registration unit 11 registers the identification information on the item and the identification information on the RF tag 3 received together with the item registration request in the tag information DB 16. The process illustrated in FIG. 8 is then ended.

FIG. 9 is an example of the flowchart of a lendable list update process by the center server 1. The process illustrated in FIG. 9 is performed at a predetermined timing, for example. The process illustrated in FIG. 9 is repeatedly performed for each item. An execution timing of the process illustrated in FIG. 9 is a predetermined date and time in a week, a month or a year, or execution is performed every time a predetermined period of time that is set in units of weeks, months, or years elapses from item registration, for example.

In OP201, the list management unit 12 acquires use history information on the target item from the use history information DB 19. In OP202, the list management unit 12 acquires the frequency of use of the target item by the owner user. The frequency of use may be acquired by dividing the number of times of use by the number of days in a target period of time, for example. However, the method of determining the frequency of use is not limited to the above-mentioned method. An average value of frequencies of use in an entire period of time may alternatively be determined.

In OP203, the list management unit 12 determines whether or not the frequency of use of the target item is smaller than a threshold. The threshold used in OP203 is an example of “first value”. In the case where the frequency of use of the target item is smaller than the threshold (OP203: YES), the process proceeds to OP204. In OP204, the list management unit 12 specifies the use pattern of the target item. A learning model may be used to specify the use pattern of the target item, for example. In OP205, the list management unit 12 adds the target item to the lendable list. At this time, if the use pattern is specified, a usable schedule based on the use pattern is also added to the lendable list. The process illustrated in FIG. 9 is then ended.

In the case where the frequency of use of the target item is equal to or greater than the threshold (OP203: NO), the process proceeds to OP206. In OP206, the list management unit 12 determines that the target item is not to be registered in the lendable list. For example, in a case where the target item is already added to the lendable list, the list management unit 12 removes the target item from the lendable list. The process illustrated in FIG. 9 is then ended.

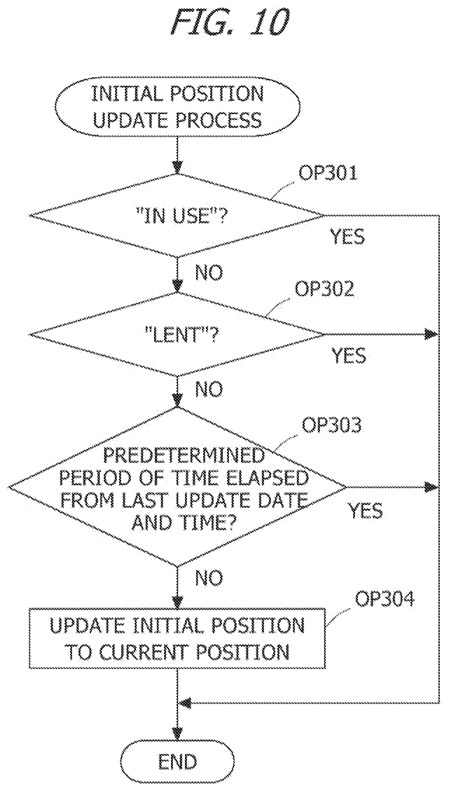

FIG. 10 is an example of the flowchart of an initial position update process by the center server 1. The initial position update process is a process of updating the initial position of an item that is registered in the tag information DB 16. The position of an item is possibly changed as appropriate within the home of the user. In the first embodiment, an item that is at its initial position is determined as not being used, and thus, the position of an item is monitored and the initial position is regularly updated. The process illustrated in FIG. 10 is performed at a predetermined timing, for example. An execution timing of the process illustrated in FIG. 10 is a predetermined time once a day, for example. An execution start time of the process illustrated in FIG. 10 is set in a time slot when the item is not likely to be used, for example. The process illustrated in FIG. 10 is performed for each record in the tag information DB 16, or in other words, for each RF tag 3.

In OP301, the list management unit 12 determines whether or not a value in the field “in use/not in use” in the record for the target RF tag 3 indicates “in use”. The process in OP301 is, in other words, determination of whether or not the target item is being used by the owner user. In the case where the target item is being used by the owner user (OP301: YES), the initial position of the target RF tag 3 is not updated, and the process illustrated in FIG. 10 is ended. In the case where the target item is not being used by the owner user (OP301: NO), the process proceeds to OP302.

In OP302, the list management unit 12 determines whether or not a value in the field “lent/not lent” in the record for the target RF tag 3 indicates “lent”. The process in OP302 is, in other words, determination of whether or not the target item is being lent to another user. In the case where the target item is being lent to another user (OP302: YES), the initial position of the target RF tag 3 is not updated, and the process illustrated in FIG. 10 is ended. In the case where the target item is not being lent to another user (OP302: NO), the process proceeds to OP303.

In OP303, the list management unit 12 determines whether or not a predetermined period of time elapsed from a value indicated by the last update date and time in the record for the target RF tag 3. That a predetermined period of time elapsed from the last update date and time indicates that the position information on the target RF tag 3 is not received for the predetermined period of time. That is, it is indicated that the target item is taken to a position that is not reached by RFID radio waves. In this case, it is unlikely that the position where the target item is placed inside the home of the owner user is changed. Accordingly, in the case where there is a lapse of the predetermined period of time from the value indicated by the last update date and time in the record for the target RF tag 3 (OP303: YES), the initial position of the target RF tag 3 is not updated, and the process illustrated in FIG. 10 is ended.

On the other hand, that the predetermined period of time has not elapsed from the last update date and time indicates that the target item is inside the home of the owner user, and there is a possibility that the position of the target item inside the home of the owner user is changed. Accordingly, in the case where the predetermined period of time has not elapsed from the value indicated by the last update date and time in the record for the target RF tag 3 (OP303: NO), the process proceeds to OP304, and in OP304, the initial position of the target RF tag 3 is updated to the current position. The process illustrated in FIG. 10 is then ended.

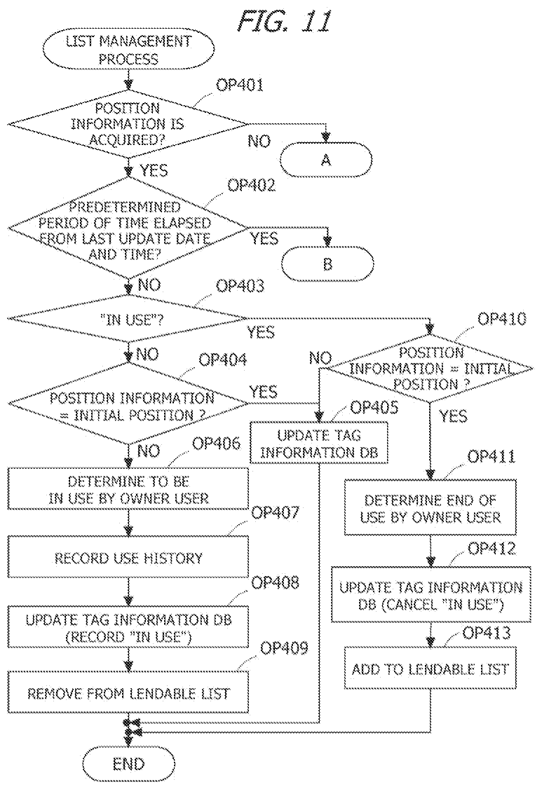

FIGS. 11, 12 and 13 are examples of the flowchart of list management process by the center server 1. The process illustrated in FIG. 11 is performed at predetermined intervals, for example. The processes illustrated in FIGS. 11 to 13 are performed for each record in the tag information DB 16, for example.

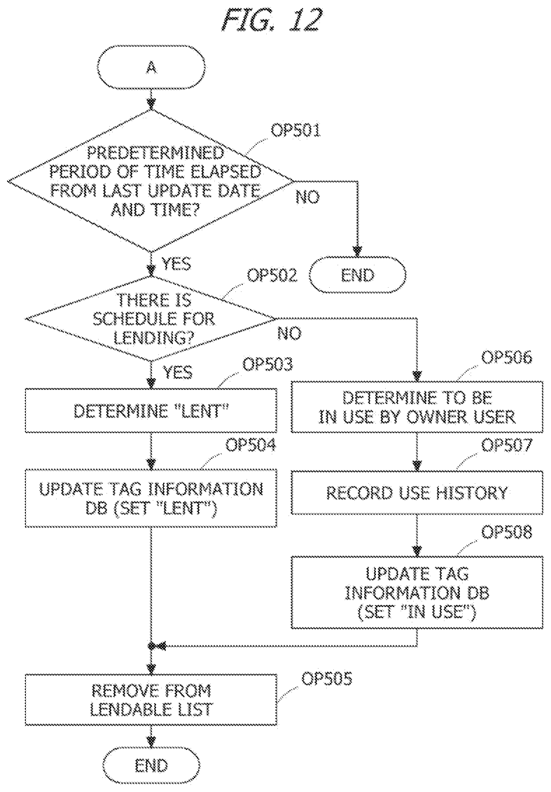

In OP401, the list management unit 12 determines whether or not the position information on the RF tag 3 is received. In the case where the position information on the RF tag 3 is received (OP401: YES), the process proceeds to OP402. In the case where the position information on the RF tag 3 is not received (OP401: NO), the process proceeds to OP501 in FIG. 12.

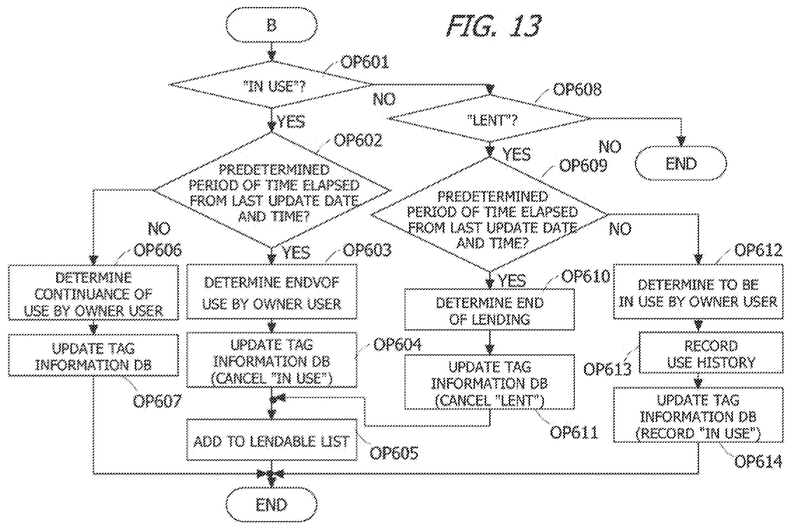

In OP402, the list management unit 12 determines whether or not a predetermined period of time elapsed from the date and time indicated by the value in the field “last update date and time” in the target record in the tag information DB 16. A threshold for time used in the determination in OP402 is set in a range of one hour to one day, for example. In the case where there is a lapse of the predetermined period of time from the date and time indicated by the value in the field “last update date and time” in the target record (OP402: YES), the process proceeds to OP601 in FIG. 13. In the case where the predetermined period of time has not elapsed from the date and time indicated by the value in the field “last update date and time” in the target record (OP402: NO), the process proceeds to OP403.

Processes from OP403 to OP413 are processes for a case where the position information on the target RF tag 3 is continuously received at predetermined intervals, or in other words, a case where the item to which the target RF tag 3 is attached is present inside the home of the owner user.

In OP403, the list management unit 12 determines whether or not the value in the field “in use/not in use” in the target record in the tag information DB 16 indicates in use. That is, in OP403, the list management unit 12 determines whether or not the item to which the target RF tag 3 is attached is being used inside the home of the owner user. In the case where the value in the field “in use/not in use” in the target record in the tag information DB 16 indicates in use (OP403: YES), the process proceeds to OP410. In the case where the value in the field in “use/not in use” in the target record in the tag information DB 16 does not indicate in use (OP403: NO), the process proceeds to OP404.

In OP404, the list management unit 12 determines whether or not the position information on the target RF tag 3 coincides with a position indicated by the value in the field “current position” in the target record in the tag information DB 16. In the case where the position information on the target RF tag 3 coincides with the position indicated by the value in the field “current position” in the target record in the tag information DB 16 (OP404: YES), it is indicated that the target item is not being used, and the process proceeds to OP405.

In OP405, the list management unit 12 updates the field “current position” in the target record in the tag information DB 16 to the received position information on the target RF tag 3. Additionally, at this time, the field “last update date and time” in the target record in the tag information DB 16 is also updated to reception date and time of the position information on the target RF tag 3, for example. Additionally, in the case where the target item is registered in the lendable list, the target item remains registered in the lendable list. Moreover, in the case where the target item is not registered in the lendable list, the target item remains not registered in the lendable list. The process illustrated in FIG. 11 is then ended.

In the case where the position information on the target RF tag 3 does not coincide with the position indicated by the value in the field “current position” in the target record in the tag information DB 16 (OP404: NO), the process proceeds to OP406. In OP406, because it is indicated that the target item is moved, the list management unit 12 determines that the target item is being used by the owner user. In OP407, the list management unit 12 records the use history of the target item in the use history information DB 19.

In OP408, the list management unit 12 updates the field “current position” in the target record in the tag information DB 16 to the received position information on the target RF tag 3. Furthermore, the list management unit 12 updates the field “in use/not in use” in the target record in the tag information DB 16 to a value indicating in use. Moreover, the list management unit 12 updates the last update date and time in the target record in the tag information DB 16 to the reception date and time of the position information on the target RF tag 3, for example.

In OP409, the list management unit 12 removes the target item from the lendable list. Additionally, in the case where the target item is not registered in the lendable list, the target item remains not registered in the lendable list. The process illustrated in FIG. 11 is then ended.

In OP410, the list management unit 12 determines whether or not the position information on the target RF tag 3 coincides with the position indicated by the value in the field “current position” in the target record in the tag information DB 16. In the case where the position information on the target RF tag 3 does not coincide with the position indicated by the value in the field “current position” in the target record in the tag information DB 16 (OP410: NO), it is indicated that the target item continues to be used by the owner user inside the home of the owner user, and the process proceeds to OP405. In OP405, the list management unit 12 updates the field “current position” in the target record in the tag information DB 16 to the received position information on the target RF tag 3. Additionally, at this time, the field “last update date and time” in the target record in the tag information DB 16 is also updated to the reception date and time of the position information on the target RF tag 3, for example. In this case, the lendable list is not updated.

In the case where the position information on the target RF tag 3 coincides with the position indicated by the value in the field “current position” in the target record in the tag information DB 16 (OP410: YES), the process proceeds to OP411. In OP411, because it is indicated that the target item is returned to the initial position from the state of being used by the owner user, the list management unit 12 determines that use by the owner user is ended.

In OP412, the list management unit 12 updates the field “current position” in the target record in the tag information DB 16 to the received position information on the target RF tag 3. Furthermore, the list management unit 12 deletes the value indicating in use in the field “in use/not in use” in the target record of the tag information DB 16, and cancels the state of being used by the owner user. Furthermore, the list management unit 12 updates the last update date and time in the target record in the tag information DB 16 to the reception date and time of the position information on the target RF tag 3, for example.

In OP413, because the target item is returned to the initial position, the list management unit 12 adds the target item to the lendable list. Additionally, in the case where the frequency of use of the target item is equal to or greater a predetermined threshold, the target item is not added to the lendable list. The process illustrated in FIG. 11 is then ended.

The process illustrated in FIG. 12 is a process for a case where the position information on the target RF tag 3 corresponding to the target record in the tag information DB 16 is not received. In OP501, the list management unit 12 determines whether or not there is a lapse of a predetermined period of time from the date and time indicated by the field “last update date and time” in the target record. The threshold for time used in the determination in OP501 is shorter than the threshold for time used in the determination in OP402 in FIG. 11. The threshold for time used in the determination in OP501 is set in a range that is three to five times a reception period of the position information on the RF tag 3, for example.

In the case where there is a lapse of the predetermined period of time from the date and time indicated by the value in the field “last update date and time” in the target record (OP501: YES), the process proceeds to OP502. In the case where the predetermined period of time has not elapsed from the date and time indicated by the value in the field “last update date and time” in the target record (OP501: NO), the process illustrated in FIG. 12 is ended.

That the position information on an RF tag 3 is not received for the predetermined period of time indicates that the item to which the RF tag 3 is attached is moved out of the home of the owner user. Accordingly, whether movement to outside the home is for use by the owner user or for lending to another user is determined by the process illustrated in FIG. 12.

In OP502, the list management unit 12 determines whether there is currently a schedule for lending in relation to the target item, by referring to the lending schedule information DB 18. In the case where there is currently a schedule for lending in relation to the target item (OP502: YES), the process proceeds to OP503. In OP503, the list management unit 12 determines that the target item is lent to another user.

In OP504, the list management unit 12 updates the field “lent/not lent” in the target record in the tag information DB 16 to a value indicating lent. Additionally, current position in the target record in the tag information DB 16 may be updated to null. In OP505, the list management unit 12 removes the target item from the lendable list. Additionally, in the case where the target item is not registered in the lendable list, the target item remains not registered in the lendable list. The process illustrated in FIG. 12 is then ended.

In the case where there is currently no schedule for lending in relation to the target item (OP502: NO), the process proceeds to OP506. In OP506, the list management unit 12 determines that the target item is moved to outside the home by the owner user and is being used by the owner user.

In OP507, the list management unit 12 records a use history in the use history information DB 19. In OP508, the list management unit 12 updates the field “in use/not in use” in the target record of the tag information DB 16 to the value indicating in use. Additionally, current position in the target record in the tag information DB 16 may be updated to null. The process then proceeds to OP505, and when the target item is removed from the lendable list, the process illustrated in FIG. 12 is ended.

The process illustrated in FIG. 13 is a process for a case where reception of the position information from a target RF tag 3 is suspended for a predetermined period of time or longer and is then resumed. Such a state is assumed to occur in a case where the target item is returned after being lent to another user, or in a case where the target item is taken outside the home by the owner user and is returned after being used, for example.

In OP601, the list management unit 12 determines whether or not the value in the field “in use/not in use” in the target record in the tag information DB 16 indicates in use. In the case where the value in the field “in use/not in use in” the target record in the tag information DB 16 indicates in use (OP601: YES), the process proceeds to OP602. In the case where the value in the field “in use/not in use” in the target record in the tag information DB 16 does not indicate in use (OP601: NO), the process proceeds to OP608.

Processes from OP602 to OP607 are processes for a case where the target item is moved from outside the home to inside when being used by the owner user. In OP602, the list management unit 12 determines whether or not the position information on the target RF tag 3 coincides with the position indicated by the value in the field “current position” in the target record in the tag information DB 16. In the case where the position information on the target RF tag 3 coincides with the position indicated by the value in the field “current position” in the target record in the tag information DB 16 (OP602: YES), the process proceeds to OP603.

In OP603, because the position information on the RF tag 3 indicates the initial position, the list management unit 12 determines that use of the target item by the owner user is ended. In OP604, the list management unit 12 updates the field “current position” in the target record in the tag information DB 16 to the received position information on the target RF tag 3. Furthermore, the list management unit 12 deletes the value indicating in use in the field “in use/not in use” in the target record in the tag information DB 16, and cancels the state of being used by the owner user. Moreover, the list management unit 12 updates last update date and time in the target record in the tag information DB 16 to the reception date and time of the position information on the target RF tag 3, for example.

In OP605, because the target item is returned to the initial position, the list management unit 12 adds the target item to the lendable list. Additionally, in the case where the frequency of use of the target item is equal to or greater than a predetermined threshold, the target item is not added to the lendable list. The process illustrated in FIG. 13 is then ended.

In the case where the position information on the target RF tag 3 does not coincide with the position indicated by the value in the field “current position” in the target record in the tag information DB 16 (OP602: NO), the process proceeds to OP606. In OP606, the list management unit 12 determines that the target item continues to be used by the owner user inside the home of the owner user. In OP607, the list management unit 12 updates the field “current position” in the target record in the tag information DB 16 to the received position information on the target RF tag 3. Additionally, at this time, the field “last update date and time” in the target record in the tag information DB 16 is also updated to the reception date and time of the position information on the target RF tag 3, for example. Additionally, in this case, the target item is already absent from the lendable list, and the lendable list is not updated. The process illustrated in FIG. 13 is then ended.

In OP608, the list management unit 12 determines whether or not the value in the field “lent/not lent” in the target record in the tag information DB 16 indicates lent. In the case where the value in the field “lent/not lent” in the target record in the tag information DB 16 indicates lent (OP608: YES), the process proceeds to OP609. In the case where the value in the field “lent/not lent” in the target record in the tag information DB 16 does not indicate lent (OP608: NO), the process illustrated in FIG. 13 is ended. Additionally, in the case where the target item is in the lendable list, the list management unit 12 removes the target item from the lendable list.

Processes from OP609 to OP614 are processes for a case where the target item is returned after being lent to another user. In OP609, the list management unit 12 determines whether or not the position information on the target RF tag 3 coincides with the position indicated by the value in the field “current position” in the target record in the tag information DB 16. In the case where the position information on the target RF tag 3 coincides with the position indicated by the value in the field “current position” in the target record in the tag information DB 16 (OP609: YES), the process proceeds to OP610.

In OP610, because the position information on the RF tag 3 indicates the initial position, the list management unit 12 determines that lending of the target item to another user is ended. In OP611, the list management unit 12 updates the field “current position” in the target record in the tag information DB 16 to the received position information on the target RF tag 3. Furthermore, the list management unit 12 deletes the value indicating lent in the field “lent/not lent” in the target record in the tag information DB 16, and cancels the state of being lent in relation to the target item. Furthermore, the list management unit 12 updates the last update date and time in the target record in the tag information DB 16 to the reception date and time of the position information on the target RF tag 3, for example. Then, the process proceeds to OP605, and the target item is added to the lendable list. The process illustrated in FIG. 13 is then ended.

In OP612, because the target item is returned to the home of the owner user but is not returned to the initial position, the list management unit 12 determines that the target item is being used by the owner user. In OP613, the list management unit 12 records a use history of the target item in the use history information DB 19.

In OP614, the list management unit 12 updates the field “current position” in the target record in the tag information DB 16 to the received position information on the target RF tag 3. Furthermore, the list management unit 12 updates the field “in use/not in use” in the target record in the tag information DB 16 to the value indicating in use. Moreover, the list management unit 12 updates the last update date and time in the target record in the tag information DB 16 to the reception date and time of the position information on the target RF tag 3, for example. Additionally, in this case, the target item is already absent from the lendable list, and the lendable list is not updated. The process illustrated in FIG. 13 is then ended.

FIG. 14 is a flowchart of the lending management process by the center server 1. The process illustrated in FIG. 14 is repeatedly performed at predetermined intervals, for example.

In OP701, the lending control unit 13 determines whether or not a rental request is received from a user terminal 4. In the case where a rental request is received from a user terminal 4 (OP701: YES), the process proceeds to OP702. In the case where a rental request is not received from a user terminal 4 (OP701: NO), the process illustrated in FIG. 14 is ended.

In OP702, the lending control unit 13 specifies an item that is a target of the rental request, from the item information DB 15. In OP703, the lending control unit 13 refers to the lendable list DB 17, and further extracts lendable item(s) from item(s) specified in OP702.

In OP704, the lending control unit 13 extracts an item that satisfies the conditions of the borrowing user regarding the owner user, from the item(s) extracted in OP703. In OP705, the lending control unit 13 extracts an item that satisfies the conditions of the owner user regarding the borrowing user, from the item(s) extracted in OP704. In OP706, the lending control unit 13 transmits, to the user terminal 4 that is the transmission source of the rental request, information about the extracted item(s) as information about lendable item(s).

In OP707, the lending control unit 13 determines whether or not a selection result indicating a rental item is received from the user terminal 4 that is the transmission source of the rental request. In the case where a selection result indicating a rental item is received from the user terminal 4 that is the transmission source of the rental request (OP707: YES), the process proceeds to OP708. In the case where a selection result indicating a rental item is not received from the user terminal 4 that is the transmission source of the rental request (OP707:NO), a standby state continues until a selection result for an item is received, and when a predetermined period of time elapses, the process illustrated in FIG. 14 is ended, for example.

In OP708, the lending control unit 13 registers a lending schedule in the lending schedule information DB 18 in relation to the item that is selected. Then, in the case where the item is desired to be transferred, the lending control unit 13 may arrange a vehicle for transferring the item. Furthermore, the lending control unit 13 may notify the owner user of the item of information about the lending schedule. The process illustrated in FIG. 14 is then ended.

FIG. 15 is an example of a flowchart of the item management process about management of an item according to a use state, performed by the center server 1. The process illustrated in FIG. 15 is performed for each item. The process illustrated in FIG. 15 is performed at a predetermined timing, for example. An execution timing of the process illustrated in FIG. 15 is, but not limited to, a predetermined date and time in a period ranging from one month to one year, for example.

In OP801, the list management unit 12 refers to the use history information DB 19, and determines whether or not a target item is used by the owner user in a predetermined period of time. The period of time used in the determination in OP801 is a period of time between previous execution of the process illustrated in FIG. 15 and current execution, or a period of time that is set in a range of immediately preceding six months to immediately preceding three years, for example. In the case where the target item is used by the owner user in the predetermined period of time (OP801: YES), the process illustrated in FIG. 15 is ended. In the case where the target item is not used by the owner user in the predetermined period of time (OP801: NO), the process proceeds to OP802. Additionally, in OP801, use or non-use by the owner user in the predetermined period of time is determined, but instead, whether or not the frequency of use is smaller than the second value may be determined.

In OP802, in relation to the target item, the list management unit 12 refers to the lending schedule information DB 18, and determines whether or not there is a user for whom the frequency of lending is equal to or greater than a predetermined value. The threshold used in OP802 is an example of “third value”. In the case where there is a user for whom the frequency of lending is equal to or greater than the predetermined value (OP802: YES), the process proceeds to OP803. In OP803, the list management unit 12 transmits, to the user terminal 4 of the owner user, a proposal to give away the target item to the other user for whom the frequency of lending is greater than the predetermined value. In the case where there are several users for whom the frequencies of lending are greater than the predetermined value, the owner user may be notified of information about every matching user, or of information about the user for whom the frequency of lending is the highest, for example. The process illustrated in FIG. 15 is then ended.

In the case where there is no user for whom the frequency of lending is equal to or greater than the predetermined value (OP802: NO), the process proceeds to OP804. In OP804, the list management unit 12 transmits, to the user terminal 4 of the owner user, a proposal to let go of the target item. The proposal to let go of the target item is a proposal of listing on a flea market application service, a proposal to give away to an unspecified user, or a proposal of disposal, for example. In the case of proposal of listing on a flea market application service, a market price of an item that is placed and that is of the same type as the target item may also be notified. The process illustrated in FIG. 15 is then ended.

Additionally, the flowcharts illustrated in FIGS. 8 to 15 are merely examples, and the processes are not limited to those in the flowcharts. Processes may be added, deleted, executed in a different order, or replaced as appropriate according to the embodiment.

<Operations and Effects of First Embodiment>

In the first embodiment, because an item that is owned by an individual and for which the frequency of use by the owner is low is lent, other users do not have to possess the item, and the number of items to be owned by each individual may be reduced. Accordingly, the amount of garbage may be reduced, for example.

Furthermore, in the first embodiment, by registering an item lending of which is allowed, management of lendable items may subsequently be performed on the side of the interindividual item lending/borrowing system 100 without bothering the owner user. Accordingly, the burden on a user in using the interindividual item lending/borrowing system 100 may be reduced, and the interindividual item lending/borrowing system 100 may be more easily used.

Furthermore, in the first embodiment, the RF tag 3 is attached to each item to monitor movement of each item. The RF tag 3 does not use a power source, and thus, a cost on the owner user to introduce and operate equipment for securing power source may be reduced to minimum, and introduction to the home of each individual may be facilitated.

Furthermore, in the first embodiment, a proposal is made to discard an item for which there is no use record for half a year to several years. This may reduce the burden on the owner user regarding management of items. Moreover, because a proposal is made to give away to a user for whom the frequency of lending is high, an item may be given away to a user who is more in need of the item.

### Other Embodiments

The embodiment described above is an example, and the present disclosure may be changed and carried out as appropriate without departing from the gist of the present disclosure.

The processes and means described in the present disclosure may be freely combined to the extent that no technical conflict exists.

A process which is described to be performed by one device may be performed divided among a plurality of devices. Processes described to be performed by different devices may be performed by one device. Each function is to be implemented by which hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. An information processing apparatus comprising a controller configured to:
monitor movement of at least one object that is owned by a first user, based on information detected by a sensor, and
create a list of lendable objects from the at least one object, based on the movement of the at least one object.

2. The information processing apparatus according to claim 1, wherein the controller is configured to add an object a frequency of use of which is smaller than a first value, among the at least one object, to the list as the lendable object.

3. The information processing apparatus according to claim 1, wherein the controller is configured to remove, from the list, a first object that is being used by the first user, among objects included in the list.

4. The information processing apparatus according to claim 1, wherein the controller is configured to remove, from the list, a second object that is no longer detected by the sensor, among objects included in the list.

5. The information processing apparatus according to claim 3, wherein, in a case where an object that is returned to a predetermined position is detected, the controller is configured to add the object that is returned to the predetermined position to the list.

6. The information processing apparatus according to claim 1, wherein the controller is configured to propose the first user to give away or discard a third object a frequency of use of which is smaller than a second value, among the at least one object.

7. The information processing apparatus according to claim 6, wherein the controller is configured to propose the first user to give away, to a second user, a fourth object a frequency of use of which by the first user is smaller than the second value and that is lent to the second user at a frequency at or greater than a third value, among the at least one object.

8. An information processing system comprising:
a sensor installed in a space where at least one object that is owned by a first user is placed; and
a controller configured to
monitor movement of the at least one object based on information detected by the sensor, and
create a list of lendable objects from the at least one object, based on the movement of the at least one object.

9. The information processing system according to claim 8, wherein the controller is configured to add an object a frequency of use of which is smaller than a first value, among the at least one object, to the list as the lendable object.

10. The information processing system according to claim 8, wherein the controller is configured to remove, from the list, a first object that is being used by the first user, among objects included in the list.

11. The information processing system according to claim 8, wherein the controller is configured to remove, from the list, a second object that is no longer detected by the sensor, among objects included in the list.

12. The information processing system according to claim 10, wherein, in a case where an object that is returned to a predetermined position is detected, the controller is configured to add the object that is returned to the predetermined position to the list.

13. The information processing system according to claim 8, wherein the controller is configured to propose the first user to give away or discard a third object a frequency of use of which is smaller than a second value, among the at least one object.

14. The information processing system according to claim 13, wherein the controller is configured to propose the first user to give away, to a second user, a fourth object a frequency of use of which by the first user is smaller than the second value and that is lent to the second user at a frequency at or greater than a third value, among the at least one object.

15. The information processing system according to claim 8, wherein
a radio frequency (RF) tag is attached to the at least one object, and
the sensor is an RF reader that is installed in the space where the at least one object is placed.

16. An information processing method comprising:
monitoring movement of at least one object that is owned by a first user, based on information detected by a sensor; and
creating a list of lendable objects from the at least one object, based on the movement of the at least one object.

17. The information processing method according to claim 16, wherein an object a frequency of use of which is smaller than a first value, among the at least one object, is added to the list as the lendable object.

18. The information processing method according to claim 16, wherein a first object that is being used by the first user, among objects included in the list, is removed from the list.

19. The information processing method according to claim 16, further comprising proposing the first user to give away or discard a third object a frequency of use of which is smaller than a second value, among the at least one object.

20. The information processing method according to claim 19, wherein the first user is proposed to give away, to a second user, a fourth object a frequency of use of which by the first user is smaller than the second value and that is lent to the second user at a frequency at or greater than a third value, among the at least one object.
